(19) United States
(12) Patent Application Publication
(10) Pub. No.: US 2013/0339147 A1
(43) Pub. Date: Dec. 19, 2013

(54) CUSTOM CONTENT AND ADVERTISING

(71) Applicant: Google Inc., Sunnyvale, CA (US)

(72) Inventors: Clarence C. Mysen, San Francisco, CA (US); Naval Verma, Sunnyvale, CA (US); Johnny Chen, Sunnyvale, CA (US)

(21) Appl. No.: 13/915,951

(22) Filed: Jun. 12, 2013

Related U.S. Application Data
(63) Continuation of application No. 11/618,391, filed on Dec. 29, 2006.

(51) Int. Cl. G06Q 30/02

(52) U.S. Cl. CPC G06Q 30/0256; G06Q 30/0273
USPC 705/14.54

(57) ABSTRACT

A device may select an advertisement in response to a search query, where the advertisement is selected based on a custom content search index. The device may further provide the selected advertisement for display with custom content search results generated based on the custom content search index.

### BACKGROUND

The World Wide Web (“web”) contains a vast amount of information. Locating a desired portion of the information, however, can be challenging. This problem is compounded because the amount of information on the web and the number of new users inexperienced at web searching are growing rapidly. Search engines assist users in locating desired portions of this information by cataloging web pages. Typically, in response to a user's request, the search engine returns references to documents relevant to the request.

A web crawler is typically used to find and retrieve documents (e.g., web pages) on the web. To retrieve a document from the web, the web crawler sends a request to, for example, a web server for a document, downloads the entire document, and then provides the document to an indexer. The indexer typically takes the text of the crawled document, extracts individual terms from the text, and sorts those terms (e.g., alphabetically) into a search index. The web crawler and indexer repeat this process as the web crawler crawls documents across the web. Each entry in the search index contains a term stored in association with a list of documents in which the term appears and the location within the document's text where the term appears. The search index, thus, permits rapid access to documents that contain terms that match search terms of a user supplied search query. To improve search performance, the indexer typically ignores common words, called stop words (e.g., the, is, on, or, of, how, why, etc.) when creating or updating the search index. Existing indexers create a single search index that contains terms extracted from all documents crawled on the web.

Generally, search engines may base their determination of the user's interest on search terms (called a search query) entered by the user. The goal of the search engine is to identify links to high quality, relevant results (e.g., web pages) based on the search query using the search index. Typically, the search engine accomplishes this by matching the terms in the search query to terms contained in the search index, and retrieving a list of documents associated with each matching term in the search index. Documents that contain the user's search terms are considered “hits” and are returned to the user. The “hits” returned by the search engine may be ranked among one another by the search engine based on some measure of the quality and/or relevancy of the hits. A basic technique for sorting the search hits relies on the degree with which the search query matches the hits. For example, documents that contain every term of the search query or that contain multiple occurrences of the terms in the search query may be deemed more relevant than documents that contain less than every term of the search query or a single occurrence of a term in the search query and, therefore, may be more highly ranked by the search engine.

### SUMMARY

According to one aspect, a device may include a memory configured to store instructions and a processor configured to execute the instructions to identify an advertisement based on a custom content search index, and provide the identified advertisement for display with custom content search results generated based on the custom content search index.

According to another aspect, a method may include causing an advertisement for custom content to be displayed in a document, where the document is unassociated with a provider of the custom content; and providing revenue or an advertising credit to an owner of the document in response to causing the advertisement to be displayed.

According to a further aspect, a method may include providing advertisements when presenting a document relating to custom content of a custom content provider; and providing at least one advertisement relating to the custom content when presenting a document relating to something other than the customer content. The at least one advertisement is provided free of charge or at a reduced charge to the custom content provider.

According to an additional aspect, a method may include providing advertisements when presenting a document relating to custom content of a custom content provider; and sharing revenue from providing the advertisements with the custom content provider.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an overview of an exemplary implementation described herein;

FIG. 2 is an exemplary diagram of a network in which systems and methods described herein may be implemented;

FIG. 3 is an exemplary diagram of the content searching system of FIG. 2;

FIG. 4 is an exemplary diagram of the web search unit of FIG. 3;

FIG. 5 is an exemplary diagram of the custom content search unit of FIG. 3;

FIG. 6 is an exemplary diagram of the ad server of FIG. 2;

FIGS. 7A and 7B provide an example of a first revenue sharing scheme in an exemplary implementation;

FIG. 8 provides an example of a second revenue sharing scheme in another exemplary implementation; and

FIG. 9 is a flowchart of an exemplary process for targeting ads for a custom content search.

### DETAILED DESCRIPTION

The following detailed description refers to the accompanying drawings. The same reference numbers in different drawings may identify the same or similar elements. Also, the following detailed description does not limit the invention.

Implementations described herein may permit a user to create their own corpora of customized content that may be accessed and searched by other users via a content searching service, such as, for example, Google Search. A content searching system may crawl the web to retrieve web content and then index the retrieved web content to create a web search index. A user may also upload or otherwise identify custom content to the content searching system, which may then index the custom content to create a custom search index that is different than the web search index. For example, the custom search index may store information different from the information stored by the web search index. In one implementation, the custom search index may store a subset of the information stored in the web search index. In this case, it may be possible for the custom search index to store pointers to information in the web search index. Alternatively, or additionally, the custom search index may store information that is not present in the web search index. Also, the custom search index may be considered different from the web search index in the sense that the custom search index may be searchable separate from the web search index.

Searching of custom content using the different custom search indexes may then be selectively permitted by users who may or may not have to be authenticated for the custom content that they wish to access and search. The custom content may be used in conjunction with a custom content business system. For example, the custom content business system may provide different techniques for sharing revenue with custom content owners and aid custom content owners in attracting users to their content.

A “document,” as the term is used herein, is to be broadly interpreted to include any machine-readable and machine-storable work product. A document may include, for example, an e-mail, a website, a business listing, a file, a combination of files, one or more files with embedded links to other files, a news group posting, a blog, an advertisement, an image, a video, a digital map, etc. In the context of the Internet, a common document is a web page. Documents often include textual information and may include embedded information (such as meta information, images, hyperlinks, etc.) and/or embedded instructions (such as Javascript, etc.).

“Content,” as the term is used herein, is to be broadly interpreted to include data that may or may not be in document form. Examples of content may include data associated with one or more documents, data in one or more databases, etc.

“Custom content,” as that phrase is used herein, is to be broadly interpreted to include content that has been uploaded by a user for indexing and/or content identified by a user for indexing.

A “user,” as that term is used herein, is to be broadly interpreted to include one or more people (e.g., a person, a group of people that may have some relationship (e.g., people associated with a business or organization), or a group of people with no formal relationship).

### OVERVIEW

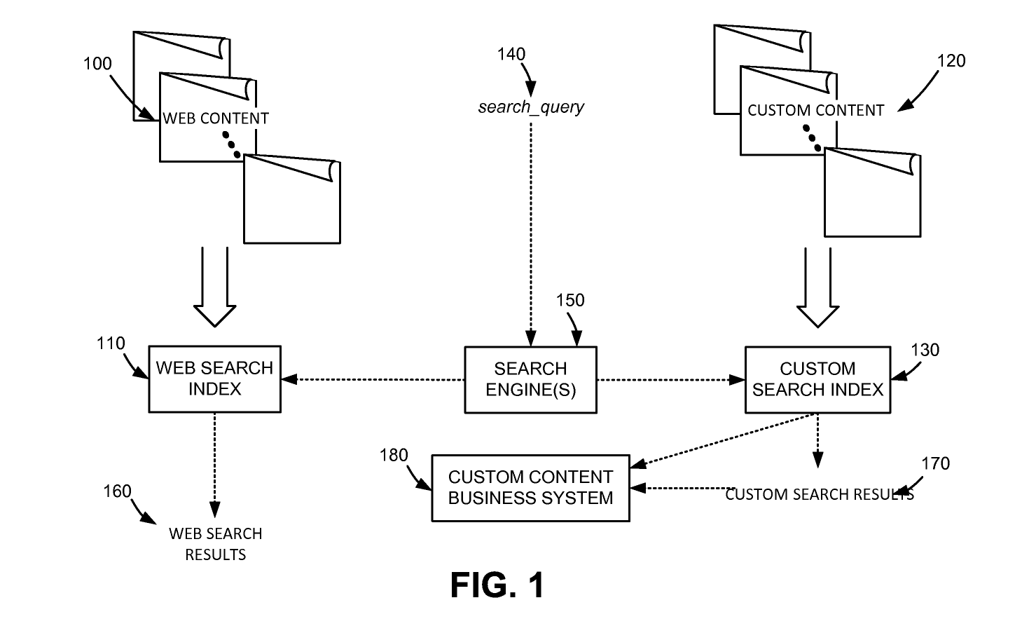

FIG. 1 is a diagram of an overview of an exemplary implementation described herein. As shown in FIG. 1, web content 100 may be retrieved using, for example, a web crawler (not shown). The web crawler may find and retrieve documents (e.g., web pages) stored on the web and extract content from the documents. For example, the web crawler may send a request to a web server for a document, download the entire document, and then provide the document to an indexer (not shown). The indexer may index the retrieved web content to create a web search index 110. The indexer extracts text from the content of the crawled document, extracts individual terms or other data from the text, and sorts those terms or other data (e.g., alphabetically) into web search index 110. Other techniques for extracting and indexing content, that are more complex than simple word-level indexing, may also be used, including techniques for indexing extensible markup language (XML) data, images, videos, etc. Each entry in web search index 110 may contain a term or other data stored in association with a list of documents in which the term or other data appears and the location within the document where the term or other data appears. Web search index 110 may subsequently be used to search for specific documents whose content matches a search query 140.

As further shown in FIG. 1, custom content 120 may also be obtained. Custom content 120 may include content uploaded by a user, content designated by the user as being part of its custom content (e.g., user designates one or more websites or web pages to be included in the user's custom content), web content that is available only to selected subscribers via subscription, or other types of content that may be aggregated and indexed separately from web search index 110 (e.g., the user or entity may designate websites or web pages that contain content about a selected topic as being included in the user's custom content). An indexer (not shown) may index the obtained custom content to create a custom search index 130 that may be different than web search index 110 (e.g., custom search index 130 may include information different from web search index 110 and/or custom search index 130 may be searchable separate from web search index 110). The indexer may take the text or other data from custom content 120, extract individual terms or other data from custom content 120, and sort those terms or other data (e.g., alphabetically) into custom search index 130. Other techniques for extracting and indexing content, that are more complex than simple word-level indexing, may also be used, including techniques for indexing XML data, images, videos, etc. Each entry in custom search index 130 may contain a term or other data stored in association with a location within custom content 120 where the term or other data appears. Custom search index 130 may subsequently be used to search for specific content of custom content 120 that matches a search query 140. Custom search index 130 may include multiple custom search indexes (not shown), each being associated with a different corpus of custom content.

Search engine(s) 150 may receive search query 140 and may selectively search either web search index 110 or custom search index 130 (or multiple different custom search indexes), or may search both web search index 110 and custom search index 130 (or other different custom search indexes), using search query 140. A search of web search index 110 by search engine(s) 150 may return web search results 160 that match search query 140. A search of custom search index 130 by search engine(s) 150 may return custom search results 170 that match search query 140. Web search results 160 and custom search results 170 may be represented together or separately with a search result document, as will be described below.

A custom content business system 180 may work in conjunction with custom search index 130 and/or custom search results 170. For example, custom content business system 180 may act in cooperation with an ad server (not shown) to target ads to users that are searching and/or accessing custom content 120. Moreover, customer content business system 180 may also act in cooperation with the ad server to provide ads as part of a predictive marketing scheme. Custom content business system 180 may, in some implementations, allow for revenue from ads to be shared with content owners.

### Exemplary Network Configuration

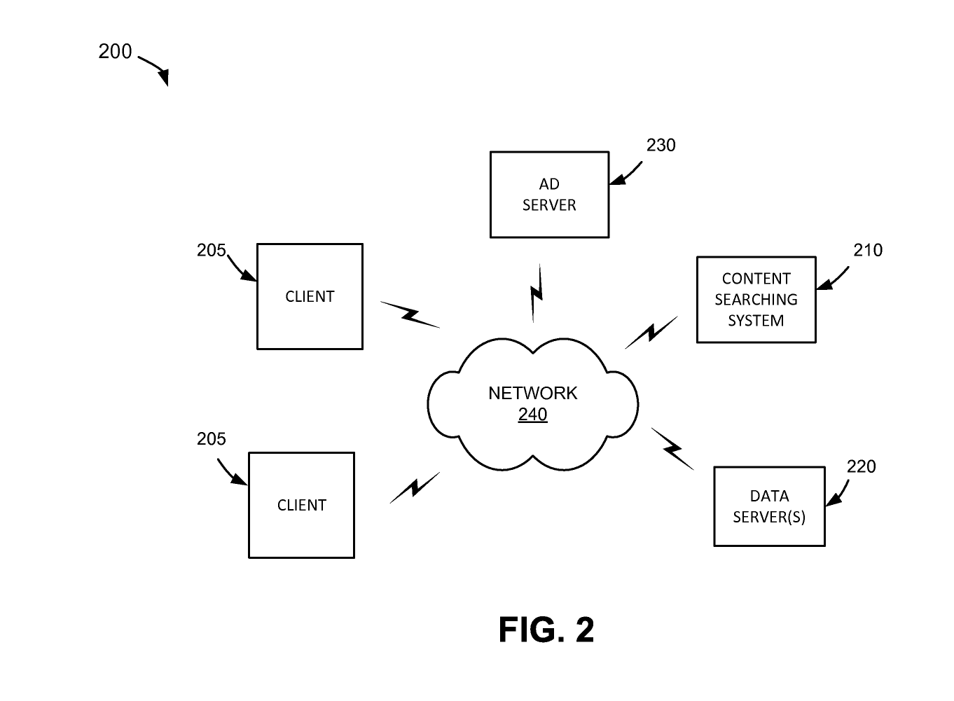

FIG. 2 is an exemplary diagram of a network 200 in which systems and methods described herein may be implemented. Network 200 may include multiple clients 205 connected to a content searching system 210, data server(s) 220, and an ad server 230 via a network 240. Two clients 205, one content searching system 210, one or more data server(s) 220, and one ad server 230 have been illustrated as connected to network 240 for simplicity. In practice, there may be more or fewer clients, content searching systems, data servers, and/or ad servers. Also, in some instances, a client 205 may perform one or more functions of content searching system 210, data server(s) 220, and/or ad server 230, and content searching system 210, data server(s) 220, and/or ad server 230 may perform one or more functions of client 205.

Clients 205 may include client entities. An entity may be defined as a device, such as a personal computer, a wireless telephone, a personal digital assistant (PDA), a laptop, or another type of computation or communication device, a thread or process running on one of these devices, and/or an object executable by one of these devices. Clients 205 may implement a browser for browsing documents stored at data server(s) 220. Clients 205 may also use the browser for accessing content searching system 210 to search documents (e.g., web content) associated with data server(s) 220 and/or custom content, as described further below.

Content searching system 210 may include one or more hardware and/or software components that access, fetch, index, search, and/or maintain general web documents and/or custom content documents. Content searching system 210 may implement a data aggregation service by crawling a corpus of documents (e.g., web pages) hosted on data server(s) 220, indexing the documents, and storing information associated with these documents in a repository of crawled documents. The aggregation service may be implemented in other ways, such as by agreement with the operator(s) of data server(s) 220 to distribute their documents via the data aggregation service.

Data server(s) 220 may store or maintain documents that may be browsed by clients 205, or may be crawled by content searching system 210. Such documents may include data related to published news stories, products, images, user groups, geographic areas, or any other type of data. For example, data server(s) 220 may store or maintain news stories from any type of news source, such as, for example, the Washington Post, the New York Times, Time magazine, or Newsweek. As another example, server(s) 230 may store or maintain data related to specific products, such as product data provided by one or more product manufacturers. As yet another example, server(s) 230 may store or maintain data related to other types of web documents, such as pages of web sites (e.g., web content).

Ad server 230 may serve advertisements for display to users of clients 205. Information regarding the advertisements may be transmitted with search results or, in some implementations, may be displayed in web pages hosted by third parties. In one implementation, the advertisements may include advertisements for custom-search content.

While content searching system 210, data server(s) 220, and ad server 230 are shown as separate entities, it may be possible for one of content searching system 210, data server(s) 220, or ad server 230 to perform one or more of the functions of the other one of content searching system 210, data server(s) 220, or ad server 230. For example, it may be possible that content searching system 210, data server(s) 220, and/or ad server 230 are implemented as a single entity. It may also be possible for a single one of content searching system 210, data server(s) 220, and/or ad server 230 to be implemented as two or more separate (and possibly distributed) devices.

Network 240 may include one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet or a combination of networks. The PLMN(s) may further include a packet-switched sub-network, such as, for example, General Packet Radio Service (GPRS), Cellular Digital Packet Data (CDPD), or Mobile IP sub-network. Clients 205, content searching system 210, data server(s) 220, and ad server 230 may connect to network 240 via wired and/or wireless connections.

### Exemplary Content Searching System

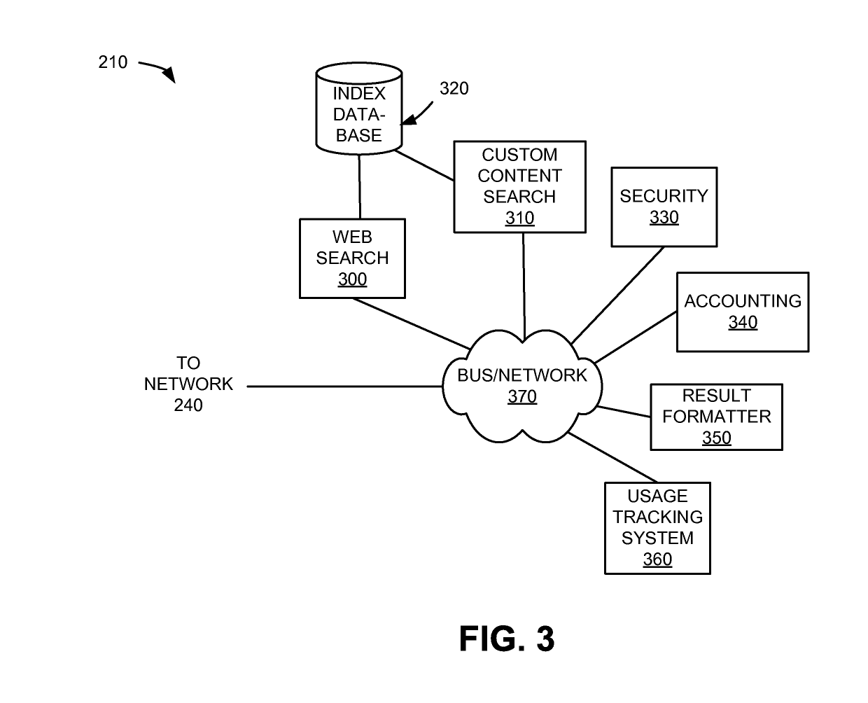

FIG. 3 is an exemplary diagram of content searching system 210. As shown in FIG. 3, content searching system 210 may include a web search unit 300, a custom content search unit 310, an index database 320, a security unit 330, an accounting unit 340, a result formatter 350, and a usage tracking system 360 interconnected with network 240 via a bus and/or network 370. Web search unit 300, custom content search unit 310, security unit 330, accounting unit 340, result formatter 350, and usage tracking system 360 may be implemented as software and/or hardware components within a single server entity, or as software and/or hardware applications distributed across multiple server entities.

Web search unit 300 may crawl documents (e.g., containing web content) stored at data server(s) 220, index the crawled documents to create a web search index 110, and search the crawled documents using the web search index. Custom content search unit 310 may obtain custom content, such as, for example, content uploaded from users, content designated by the user as being part of its custom content (e.g., the user designates one or more web sites or web pages to be included in the user's custom content), content obtained from sources that require subscriptions for access to the content, and/or content on a given topic that may be obtained and aggregated from multiple sources, index the content in separate custom search indexes to create multiple different custom search indexes 130 and search the custom content using one or more of the different custom search indexes.

Index database 320 may store a web search index 110 and one or more custom search indexes 130. Index database 320 may store web search index 110 and the one or more custom search indexes 130 as different data structures that may be searched independently of one another. Alternatively, index database 320 may store one or more custom search indexes 130 within the same data structure as web search index 110 in a manner that they may be searched independently of one another. Each of custom search indexes 130 may include multiple index entries, with each entry containing a term stored in association with an item of custom content in which the term appears, and a location within the custom content's text where the term appears. A custom search engine may search custom search indexes 130, based on a received search query, to match terms of the search query with terms contained in entries in custom search indexes 130.

Security unit 330 may authenticate users desiring to upload custom content to custom content search unit 310 and/or may authenticate users desiring to search one or more custom content indexes 130 associated with custom content. Security unit 330 may authenticate users by passing authentication tokens to the users which define the custom search indexes that are accessible by a particular user, and may contain security keys to permit encryption for sensitive information. Security unit 330 may authenticate users and authorize custom content search unit 310 to permit access to selected custom search indexes to the authenticated users.

Accounting unit 340 may establish and modify user access rights, may record and report user access to selected custom search indexes, may obtain feedback from users accessing given custom search indexes, and/or may track and control access to given custom search indexes based on whether users have subscribed to the custom search indexes.

Result formatter 350 may return search results obtained from web search unit 300 and/or custom content search unit 310 in a formatted and organized manner. Result formatter 350 may combine custom content search results together with web content search results in a way that is meaningful to the user (e.g., in a hypertext markup language (HTML) page).

Usage tracking system 360 may track usage patterns of custom content 120 to permit content providers to determine what custom content is being viewed, clicked, purchased, etc. for pricing and/or marketing purposes. Usage patterns may also aid in ranking custom content 120, and/or in determining what content is potentially more useful or valuable to users (e.g., for the purposes of promoting certain content to certain users). Usage tracking system 360 may promote content providers and/or custom content 120, determined to be valuable, in advertisements (e.g., via an advertising system), and/or in custom search results 170.

Bus and/or network 370 may include a communication path, such as, for example, a system bus or a network that permits web search unit 300, custom content search unit 310, security unit 330, accounting unit 340, result formatter 350, and usage tracking system 360 to communicate with one another.

Although FIG. 3 shows exemplary components of content searching system 210. In other implementations, content searching system 210 may include fewer or additional components than depicted in FIG. 3. In still other implementations, one or more components of content searching system 210 may perform the tasks performed by other components of content searching system 210.

### Exemplary Web Search Unit

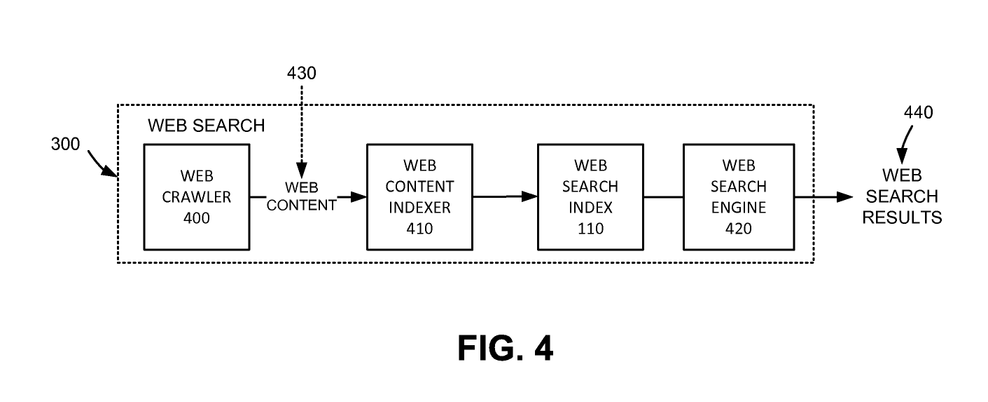

FIG. 4 is an exemplary diagram of web search unit 300. As shown in FIG. 4, web search unit 300 may include a web crawler 400, a web content indexer 410, a web search index 110, and a web search engine 420.

Web crawler 400 may find and retrieve web content 430 (e.g., web documents) and provide the retrieved web content 430 to web content indexer 410. For example, web crawler 400 may send a request to a web server for a web document, download the entire web document, and then provide the web document to web content indexer 410. Web content indexer 410 may index web content 430 to create web search index 110. For example, web content indexer 410 may take the text or other data of a given crawled document, extract individual terms or other data from the text of the document, and sort those terms or other data (e.g., alphabetically) in web search index 110. Other techniques for extracting and indexing content, that are more complex than simple word-level indexing, may also be used, including techniques for indexing XML data, images, videos, etc. Each entry in web search index 110 may contain a term or other data stored in association with a list of documents in which the term or other data appears and the location within the document where the term or other data appears.

Web search engine 420 may search web search index 110, based on a received search query, to match terms of the search query with terms or other data (e.g., video, images, etc.) contained in entries in web search index 110. Web search engine 420 may retrieve a corresponding list of documents from each entry in web search index 110 that matches a term of the search query. The lists of documents retrieved from one or more entries in web search index 110 may be returned as web search results 440. In one implementation, each result of web search results 440 may include a uniform resource locator (URL) associated with a corresponding search result document and, possibly, a snippet of content extracted from the corresponding search result document.

Although FIG. 4 shows exemplary components of web search unit 300, in other implementations, web search unit 300 may include fewer or additional components than depicted in FIG. 4. In still other implementations, one or more components of web search unit 300 may perform the tasks performed by other components of web search unit 300.

### Exemplary Custom Search Unit

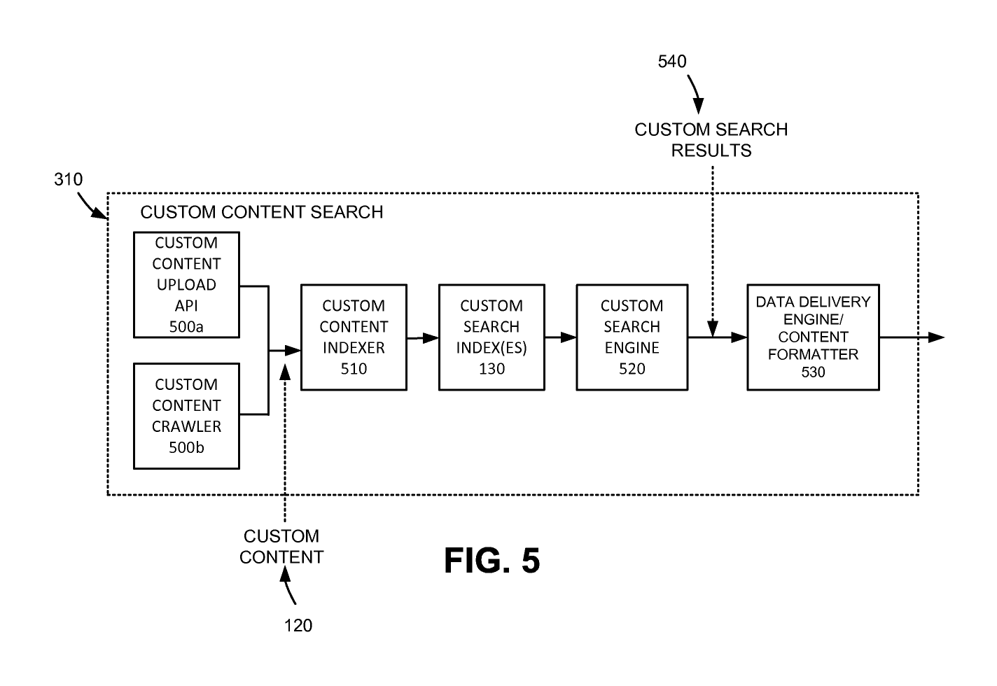

FIG. 5 is an exemplary diagram of custom content search unit 310. As shown in FIG. 5, custom content search unit 310 may include a custom content upload Application Programmer Interface (API) 500a, a custom content crawler 500b, a custom content indexer 510, one or more custom search indexes 130, a custom search engine 520, and a data delivery engine/content formatter 530.

Custom content upload API 500a may receive custom content 120 uploaded from one or more users (e.g., one or more authenticated users). The uploaded content may include data of any type or format. In one implementation, the uploaded content may include meta-data (e.g., XML data). The meta-data may include content metadata with pointers to actual content. In another implementation, custom content upload API 500a may include a translation engine for translating any type or format of uploaded data into a particular type or format of data that can be more easily processed by custom content indexer 510. Custom content upload API 500a may pass the received custom content 120 to custom content indexer 510.

Custom content crawler 500b may crawl specific content on the web to retrieve documents that may be indexed in a corresponding custom search index 130. For example, custom content crawler 500b may crawl available documents on the web containing content directed to a specific topic (e.g., dogs, football, etc.) or documents identified by a custom content provider. Custom content crawler 500b may, in some implementations, need to be authenticated by content providers associated with specific custom content crawled on the web and/or one or more databases. Custom content crawler 500b may pass the crawled custom content 120 to custom content indexer 510.

Custom content indexer 510 may index custom content 120 to create custom search index(es) 130. For example, custom content indexer 510 may take the text or other data of custom content 120, extract individual terms from the text or other data of custom content 120, and sort those terms or other data (e.g., alphabetically) into a single custom search index 130. Other techniques for extracting and indexing content, that are more complex than simple word-level indexing, may also be used, including techniques for indexing XML data, images, videos, etc. Each entry in a custom search index 130 may contain a term or other data stored in association with an item of content in which the term or other data appears and a location within the custom content where the term or other data appears.

Custom search engine 520 may search custom search index(es) 130, based on a received search query, to match terms of the search query with terms or other data contained in entries in custom search index(es) 130. If custom search index(es) 130 includes multiple different custom search indexes, then custom search engine 520 may search, based on the received search query and, possibly, user authentication, selected ones of the different custom search indexes. Custom search engine 520 may retrieve a corresponding list of items of custom content from each entry in custom search index 130 that matches a term of the search query. The lists of items of content retrieved from one or more entries in custom search index 130 may be returned as custom search results 540. In one implementation, each result of custom search results 540 may include a URL associated with a corresponding search result document and, possibly, a snippet of content extracted from the corresponding search result document.

Data delivery engine/content formatter 530 may receive the search results from custom search engine 520, format the search results into a meaningful data format (e.g., into an HTML document) that can be received and displayed by the user (e.g., via a web browser). Data deliver engine/content formatter 530 may customize the formatting of the search results (e.g., the content and visual format of the data) received from custom search engine 520 based on individual user preferences or based on the preferences of the user that uploaded/selected the custom content being searched.

Although FIG. 5 shows exemplary components of custom content search unit 310, in other implementations, custom content search unit 310 may include fewer or additional components than depicted in FIG. 5. In still other implementations, one or more components of custom content search unit 310 may perform the tasks performed by other components of custom content search unit 310.

### Exemplary Ad Server

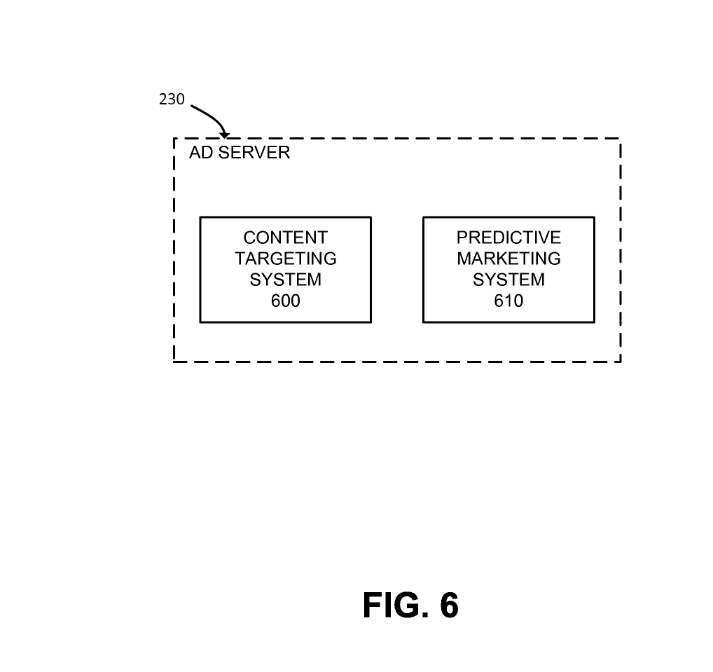

FIG. 6 illustrates an exemplary configuration of ad server 230 according to an exemplary implementation. Ad server 360 may include a content targeting system 600, and a predictive marketing system 610. Content targeting system 600 and predictive marketing system 610 may be implemented as software and/or hardware components within a single server entity, or as software and/or hardware components distributed across multiple server entities.

Content targeting system 600 may target ads to users performing custom content searches. Content targeting system 600 may target ads based on, for example, custom search indexes 130 created for custom content 120 and/or on user behavior (e.g., user patterns, such as clicks, purchases, views, etc.), which may be obtained, for example, from user tracking system 360. Stronger ad targeting metrics may appear in relation to custom content searches because users of custom content automatically segregate themselves from the rest of the population. Thus, it becomes possible for ads to be better targeted to users of certain custom content types. For example, subscribers to an automotive-content group are much more likely targets for ads relating to auto-care, auto-repair, etc. Advertisers, as such, could specifically target certain content groups (e.g., all public auto content), specific content (e.g., content for a particular hot-rod magazine), or even specific articles (e.g., only articles associated with engine care). In this way, content targeting system 600 can perform very specific ad targeting, allowing advertisers to target specific custom content or groups of custom content. Moreover, this specific ad targeting allows for revenue sharing with content owners that did not previously have monetization strategies for their content. Content owners may, therefore, make their content available for ad targeting, which will provide the content owners with the ability to share in the revenues from the ads associated with their content (e.g., targeted impression-based ads or click-based ads).

Predictive marketing system 610 may predict the value of showing an ad impression to a user. This predicted value may be used in providing ads (e.g., in deciding whether to show or not show a particular ad). Predictive marketing system 610 may provide (or act in cooperation with) an automated experimentation system that automatically creates random marketing campaigns to locate keywords for custom content search ads. The automated experimentation system may generate likely keywords based on searches users perform (received from, for example, usage tracking system 360), and may take into account other relevant metadata in the content, along with the purchase value of such content. Predictive marketing system 610 may then predict the value (e.g., predicted revenue) of showing the ad impression to the user and decide if the ad is actually worth showing. Content owners can also help guide predictive marketing system 610 by defining sets of possible keywords to target, as well as by creating promotional periods where content costs are reduced to users (this will, in effect, boost the expected utility to users). The promotional periods may involve a simple reduction in the cost of accessing the custom content or may provide coupons that reduce a user's cost of accessing the custom content. Because promotions would change the probability of purchases by users, these campaigns could have strong effects on the predictive model and predictive marketing system 610's decision to show or not show ads. Predictive marketing system 610 may also cause ads to be displayed in a first custom owner's content for other related custom content based on the patterns of users of the other custom content.

Content targeting system 600 and/or predictive marketing system 610 may cause ads to be shown based, for example, on an entire custom search index (e.g., a custom search index relating to dogs), a particular document (or documents) in a customer search (e.g., a document related to Labrador retrievers), and/or other information. Content prices can be directly shown to the user from the ad so the user can more easily decide if the content is valuable. Promotional periods (e.g., coupons, lower prices, etc.) can be reflected in prices shown to users and can also boost ad rankings because lower prices increase the likelihood that users would purchase the content.

### Revenue Sharing Schemes for Custom Content Searches

The ability to perform custom content searches provides opportunities for content owners to profit in a number of different ways. For example, as described above, a custom content owner may allow ads to be targeted to users that perform custom content searches (e.g., ads may be displayed on the same web page that provides custom content search results) and users that access the custom content owner's content (e.g., ads may be displayed on documents (e.g., articles) that are accessed by users). The content owner may share in the profit (e.g., with the ad provider) that is obtained from ad impressions and/to ad clicks.

Another type of revenue sharing scheme that may be employed is a zero-revenue, revenue sharing scheme. It is recognized that, in some situations, a content owner may simply want to make his/her content visible to a wider audience. For example, a content owner of a set of how-to articles may desire to market the articles to a wider audience without necessarily making significant profits. The content owner may allow ad server 230 to show ads during custom content searches and/or during access of documents associated with the content owner. The content owner may also allow the revenues from those ads to be fed back into the ad network as credits for advertisements. Ad server 230 may then auto-generate ads for the owner's custom content and mix the auto-generated ads with other potential ads. In this way, ad server 230 would provide ads that attract users to the owner's content via the ad network with the cost of these ads being fed by the proceeds of the ad impressions and/or ad clicks generated by the owner's content.

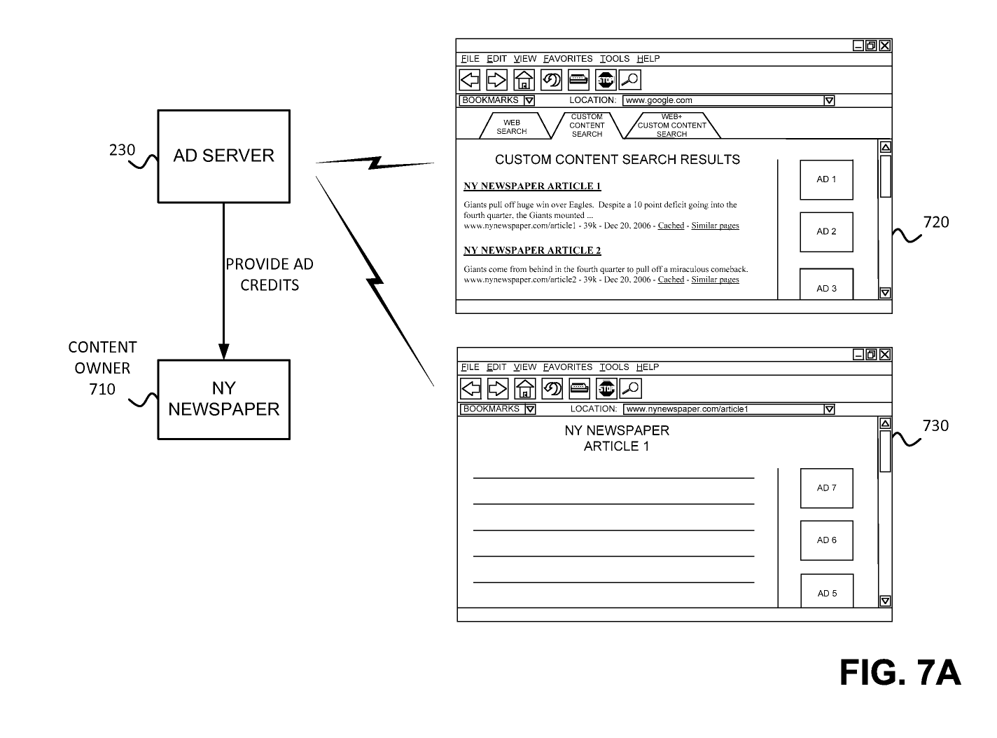

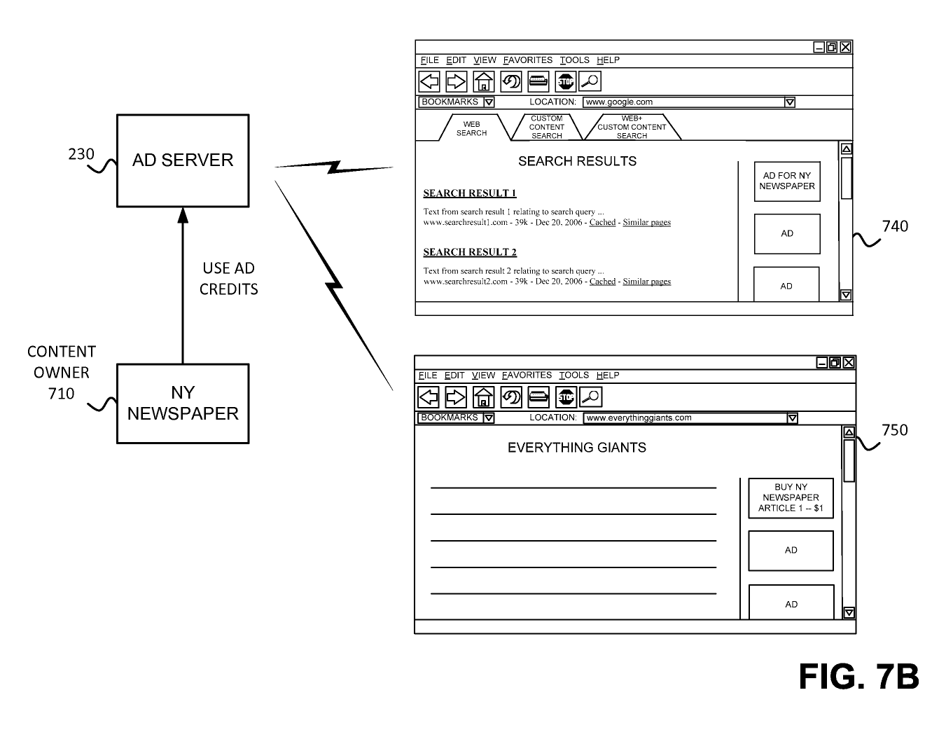

FIGS. 7A and 7B illustrate the above revenue sharing concept. As illustrated in FIG. 7A, assume that a content owner 710 provides a subscription-based newspaper (called “NY Newspaper”). Content owner 710 may allow ad server 230 to show ads when users search the NY Newspaper 720 and when users view articles from the NY Newspaper 730. Instead of sharing in the revenue generated by the ads, assume that content owner 710 receives ad credits from ad server 230 that may be used by content owner 720 to cause ad server 230 to serve ads for the NY Newspaper. As illustrated in FIG. 7B, content owner 710 may use the ad credits, which causes ad server 230 to provide ads for NY Newspaper and/or articles within NY Newspaper. In FIG. 7B, ad server 230 causes an ad for the NY Newspaper to be shown on a document providing search results 740. Ad server 230 may cause ads for the NY Newspaper to be shown on a document providing web search results and/or other custom content search results (custom content searches of other content relating to or not relating to the NY Newspaper). In this way, ad server 230 may attract users to the NY Newspaper via the ads, without content owner 710 having to pay for the ads.

Yet another type of revenue sharing scheme that may be employed is a content referral scheme. In this scheme, referral bonuses may be provided to web site owners (e.g., web site owners whose content is highly related to customer content) that refer users to custom content. Thus, in this revenue sharing scheme, purchases are tracked back to a referring site (via standard browser referrer information or through other tracking systems) and the referring site may be provided with a portion of the revenue generated from those ads or ad credits, as described above.

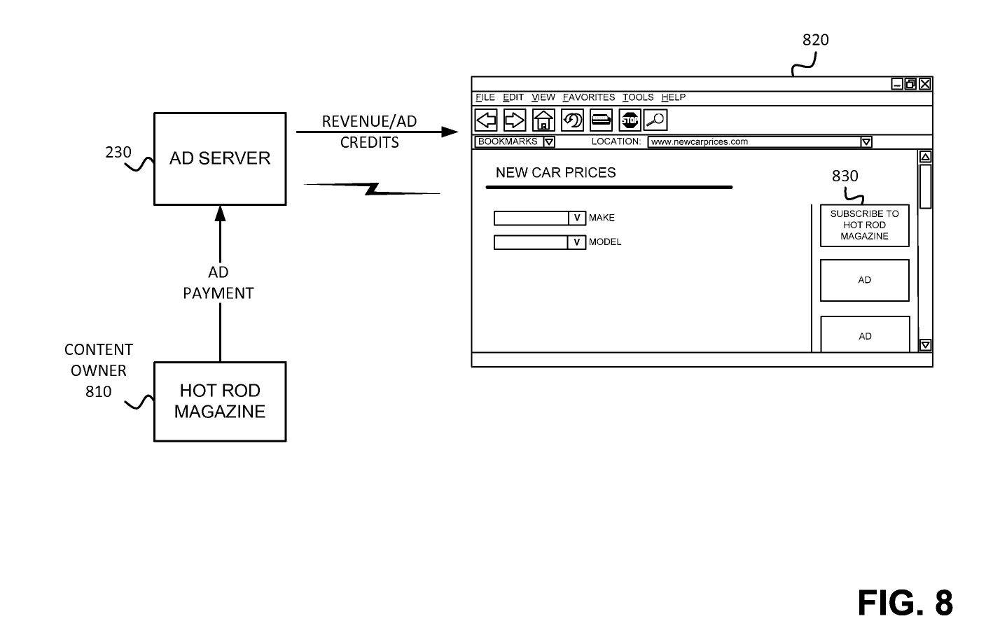

FIG. 8 illustrates the above revenue sharing concept. As illustrated in FIG. 8, assume that a content owner 810 provides a subscription-based magazine (called “Hot Rod Magazine”). Content owner 810 may pay ad server 230 to present ads for its magazine. Assume that an owner of a web site 820 that provides information regarding new car prices has entered into a revenue sharing agreement with ad server 230. Thus, ad server 230 may show ads on web site 820 and may share the revenue from the ads with (or provide ad credits to) the owner of web site 820. If a user accesses web site 820, ad server 230 may show an ad 830 for the Hot Rod Magazine and may share the revenue obtained from content owner 810 with the owner of web site 820.

### Exemplary Processing

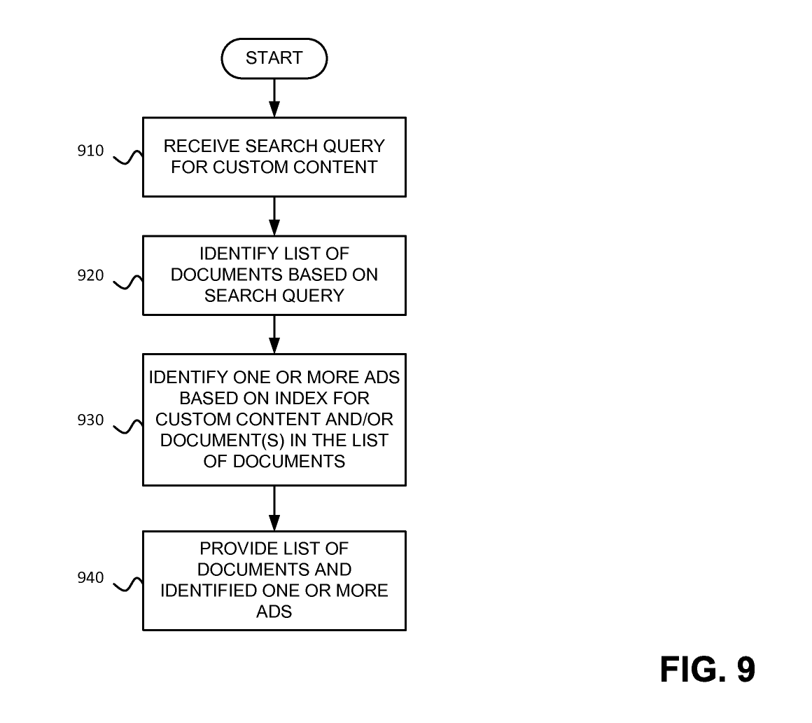

FIG. 9 is a flowchart of an exemplary process for targeting ads for a custom content search. The process exemplified by FIG. 9 may be performed by content searching system 210, ad server 230, and/or other devices. As shown, processing may begin by receiving a search query for custom content (block 910). For example, a search query may be received from a client (e.g., client 205 in FIG. 2) for a subscription-based on-line magazine.

A list of documents may be identified based on the search query (block 920). For example, custom search engine 520 may search custom search index(es) 130 associated with the subscription-based on-line magazine, using the term(s) in the received search query, to match the terms of the search query with terms or other data contained in entries in custom search index(es) 130. Custom search engine 520 may retrieve a corresponding list of documents of custom content from each entry in custom search index 130 that matches a term of the search query. In some implementations, custom search engine 520 (or another device) may identify, prior to performing the search of custom search index(es) 130, users who have permission to access certain custom indexes via an authentication procedure or users who have subscribed to freely available custom indexes and only perform the search of custom search index(es) 130 if the user is permitted to search custom search index(es) 130.

One or more ads may be identified based on the search query (block 930). Ads may be identified based on custom search index(es) 130 (e.g., based on a topic of the custom search index(es) 130 or terms or other data located in custom search index(es) 130) associated with the subscription-based on-line magazine. Alternatively or additionally, ads may be identified based on one or more of the documents in the list of documents. Key word matching, prediction information obtained from user tracking (e.g., predictions based on users' patterns, such as clicks, purchases, views, etc.), and/or other techniques may be used to identify those ads that are relevant to custom search index(es) 130 and/or the one or more documents. In one implementation, advertisers may be allowed to bid on ads to be shown next to custom search results. For example, if ad auctioning is used, advertiser bidding may be used to set ad ranking In this situation, therefore, certain candidate ads may be selected over other candidate ads.

The list of documents and the identified one or more ads may be provided to client 205 (block 940). The list of documents and the identified one or more ads may be displayed on a graphical user interface of client 205. The ads may be set apart from the list of documents in the graphical user interface (e.g., as illustrated in the exemplary graphical user interface depicted in FIGS. 7A and 7B).

### CONCLUSION

Implementations described herein provide illustration and description, but is not intended to be exhaustive or to limit the implementations to the precise form disclosed. Modifications and variations are possible in light of the above teachings, or may be acquired from practice of the implementations. For example, while a series of acts has been described with regard to FIG. 9, the order of the acts may be modified in other implementations. Further, non-dependent acts may be performed in parallel.

It will be apparent that aspects described herein may be implemented in many different forms of software, firmware, and hardware in the implementations illustrated in the figures. The actual software code or specialized control hardware used to implement these aspects is not limiting of the aspects. Thus, the operation and behavior of the aspects have been described without reference to the specific software code, it being understood that software and control hardware could be designed to implement the aspects based on the description herein. No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1-20. (canceled)

21. A computer-implemented method comprising:
determining that a set of search results that is identified in response to receiving a search query from a user of a search system includes a particular search result that is identified based on a search of a custom content index, wherein the custom content index is an index of custom content that was exposed to the search system by an owner of the custom content, and wherein the user is a non-owner of the custom content;
determining that the owner of the custom content has indicated that the custom content is to be made available for targeting of advertisements to users of the search system other than the owner; and
based on determining that the owner of the custom content has indicted that the custom content is to be made available for targeting of advertisements, serving an advertisement with a search engine results page that identifies one or more of the search results to the user of the search system.

22. The method of claim 21, comprising:
receiving the search query from a user;
determining that the user is authorized to access search results using the custom content search index; and
in response to determining that the user is authorized to access search results using the custom content search index, obtaining the set of search results in response to the search query.

23. The method of claim 21, comprising:
determining an amount of profit generated from targeting advertisements based searches of the custom content; and
determining a credit for the owner of the custom content based on the amount of profit.

24. The method of claim 23, wherein determining a credit for the owner of the custom content based on the amount of profit comprises determining one or more advertisement credits for the owner of the custom content.

25. The method of claim 21, comprising:
determining that second content exposed to the search system by a second different owner of custom content is relevant to the search query; and
generating the advertisement using the second content.

26. The method of claim 21, comprising:
determining a topic of the custom content exposed to the search system by the owner of the custom content; and
selecting the advertisement based on a topic of the custom content.

27. The method of claim 21, comprising:
receiving one or more keywords from the owner of the custom content; and
selecting the advertisement based on the one or more keywords.

28. The method of claim 21, comprising:
receiving a bid from an advertiser to place the advertisement on a custom content search results page;
determining an advertisement ranking using the bid received from the advertiser; and
selecting the advertisement based on the advertisement ranking.

29. A system comprising:
one or more computers and one or more storage devices storing instructions that are operable, when executed by the one or more computers, to cause the one or more computers to perform operations comprising:
determining that a set of search results that is identified in response to receiving a search query from a user of a search system includes a particular search result that is identified based on a search of a custom content index, wherein the custom content index is an index of custom content that was exposed to the search system by an owner of the custom content, and wherein the user is a non-owner of the custom content;
determining that the owner of the custom content has indicated that the custom content is to be made available for targeting of advertisements to users of the search system other than the owner; and
based on determining that the owner of the custom content has indicted that the custom content is to be made available for targeting of advertisements, serving an advertisement with a search engine results page that identifies one or more of the search results to the user of the search system.

30. The system of claim 29, wherein the operations comprise:
receiving the search query from a user;
determining that the user is authorized to access search results using the custom content search index; and
in response to determining that the user is authorized to access search results using the custom content search index, obtaining the set of search results in response to the search query.

31. The system of claim 29, wherein the operations comprise:
determining an amount of profit generated from targeting advertisements based searches of the custom content; and
determining a credit for the owner of the custom content based on the amount of profit.

32. The system of claim 31, wherein determining a credit for the owner of the custom content based on the amount of profit comprises determining one or more advertisement credits for the owner of the custom content.

33. The system of claim 29, wherein the operations comprise:
determining that second content exposed to the search system by a second different owner of custom content is relevant to the search query; and
generating the advertisement using the second content.

34. The system of claim 29, wherein the operations comprise:
determining a topic of the custom content exposed to the search system by the owner of the custom content; and
selecting the advertisement based on a topic of the custom content.

35. The system of claim 29, wherein the operations comprise:
receiving one or more keywords from the owner of the custom content; and
selecting the advertisement based on the one or more keywords.

36. The system of claim 29, wherein the operations comprise:
receiving a bid from an advertiser to place the advertisement on a custom content search results page;
determining an advertisement ranking using the bid received from the advertiser; and
selecting the advertisement based on the advertisement ranking.

37. A computer program product, encoded on one or more non-transitory computer storage media, comprising instructions that when executed by one or more computers cause the one or more computers to perform operations comprising:
determining that a set of search results that is identified in response to receiving a search query from a user of a search system includes a particular search result that is identified based on a search of a custom content index, wherein the custom content index is an index of custom content that was exposed to the search system by an owner of the custom content, and wherein the user is a non-owner of the custom content;
determining that the owner of the custom content has indicated that the custom content is to be made available for targeting of advertisements to users of the search system other than the owner; and
based on determining that the owner of the custom content has indicted that the custom content is to be made available for targeting of advertisements, serving an advertisement with a search engine results page that identifies one or more of the search results to the user of the search system.

38. The computer program product of claim 37, wherein the operations comprise:
receiving the search query from a user;
determining that the user is authorized to access search results using the custom content search index; and
in response to determining that the user is authorized to access search results using the custom content search index, obtaining the set of search results in response to the search query.

39. The computer program product of claim 37, wherein the operations comprise:
determining an amount of profit generated from targeting advertisements based searches of the custom content; and
determining a credit for the owner of the custom content based on the amount of profit.

40. The computer program product of claim 39, wherein determining a credit for the owner of the custom content based on the amount of profit comprises determining one or more advertisement credits for the owner of the custom content.
